(19) United States
(12) Patent Application Publication
(10) Pub. No.: US 2008/0271986 A1
(43) Pub. Date: Nov. 6, 2008

(54) Method for Isotope Separation of Ytterbium

(75) Inventors: Do-Young Jeong, Daejeon (KR); Hyun-Min Park, Daejeon (KR); Jae-Min Han, Daejeon (KR); Cheol-Jung Kim, Daejeon (KR)

Correspondence Address: MCDERMOTT WILL & EMERY LLP, 18191 VON KARMAN AVE., SUITE 500, IRVINE, CA, 92612-7108, US

(73) Assignee: KOREA ATOMIC ENERGY RESEARCH INSTITUTE, Yusung-gu , Daejeon (KR)

(21) Appl. No.: 12/066,026

(22) PCT Filed: Aug. 22, 2006
(86) PCT No.: PCT/KR2006/003297

§ 371 Date: Mar. 6, 2008

(30) Foreign Application Priority Data
Sep. 8, 2005 (KR) 10-2005-0083821

(51) Int. Cl. B01D 59/34

(52) U.S. Cl. 204/157.22

(57) ABSTRACT

A method for isotope separation of ytterbium comprises isotope-selective photoionizing of a target isotope by use of a laser, and photoionizing of the target isotope from a metastable state to a continuum state or an auto-ionization state through excited states. The photoionized isotope ions of ytterbium can be separated within an electric field. With the method, it is possible to separate a great amount of ytterbium isotope by use of a simple apparatus while ensuring a highly economic efficiency in comparison with a conventional EM method.

### TECHNICAL FIELD

The present invention relates to a method for laser isotope separation of ytterbium, and more particularly to a method for laser isotope separation of ytterbium employing isotope-selective photoionization of a target isotope followed by extraction of ionized target isotope.

### BACKGROUND ART

Natural ytterbium (Yb) consists of seven isotopes, ¹⁷⁶Yb, ¹⁷⁴Yb, ¹⁷³Yb, ¹⁷²Yb, ¹⁷¹Yb, ¹⁷⁰Yb, and ¹⁶⁸Yb in the abundance ratios of 12.7%, 31.8%, 16.1%, 21.9%, 14.3%, 3.05%, and 0.13%, respectively. Among these isotopes of ytterbium, ¹⁷⁶Yb and ¹⁶¹Yb are very useful in view of industry.

Ytterbium comprising ¹⁷⁶Yb in an enrichment ratio of about 95% is used as a source material of ¹⁷⁷Lu radioactive isotope. ¹⁷⁷Lu with a half-life period (T_{1/2}) of 6.89 days emits β subatomic particles having an energy of 0.421 MeV and 0.133 MeV and gamma (γ) rays having an energy of 208 keV and 113 keV simultaneously. Accordingly, since ¹⁷⁷Lu emanates the β particles suitable for medical treatment and the γ rays suitable for image pickup simultaneously, it is evaluated as an ideal radioactive isotope with which medical treatment and image pickup can be obtained at the same time.

¹⁷⁷Lu is one of radioactive isotopes generated in a nuclear reactor. ¹⁷⁷Lu is generated by a direct generation process in which a neutron is irradiated to a ¹⁷⁶Lu enriched target to generate ¹⁷⁷Lu according to ¹⁷⁶Lu(n, γ) ¹⁷⁷Lu reaction, or an indirect generation process in which a ¹⁷⁶Yb enriched target is employed as a raw material according to ¹⁷⁶Yb(n, γ)¹⁷⁷Yb(β→)¹⁷⁷Lu reaction. In the indirect generation process, ¹⁷⁷ Yb is generated by virtue of (n, γ) reaction through irradiation of a neutron to a ¹⁷⁶Yb enriched target, and ¹⁷⁷Yb with a half-life period of 1.9 hours is converted to ¹⁷⁷Lu via β decay. As such, by chemically separating ¹⁷⁷Lu from Yb through irradiation of the neutron, it is possible to obtain carrier-free ¹⁷⁷Lu having a specific activity up to 1.1×10⁵ Ci/g. It is expected that the carrier-free ¹⁷⁷Lu having the high specific activity will increase in utility as a medicament for new radioimmunotherapy (RIT) with respect to prostate cancer, breast cancer, and the like, thereby increasing a demand for the ¹⁷⁶Yb enriched target as a source material of the carrier-free ¹⁷⁷Lu.

In addition, ytterbium comprising ¹⁶⁹Yb in an enrichment ratio of 20% is used as a source material of ¹⁶⁹Yb radioactive isotope which is generated by irradiating the neutron in the nuclear reactor. Since ¹⁶⁹Yb is advantageous in making a small-sized radioactive source due to its high specific activity, and does not emit β subatomic particles, it has very excellent characteristics compared with ⁶⁰Co or ¹⁹²Ir which is widely used as a radioactive isotope for nondestructive testing. In particular, ¹⁶⁹Yb can be actively used in a small-sized high precision radiator for stainless steel or zirconium.

Electromagnetic (EM) method is the unique commercialized one used for isotope separation of ytterbium. The EM method employs a principle wherein, when an ytterbium ion beam having a single energy passes through a magnetic field uniformly distributed in space, a locus of the ytterbium ion beam splits spatially according to the isotopes of ytterbium. The EM method is a technique developed in the middle of the 20th century, and has a merit in view of its wide applicability of elements. However, the EM method has disadvantages in that it has a low yield per unit time, and requires a high separation cost.

In order to solve the disadvantages of the EM method, an atomic vapor laser isotope separation (AVLIS) method was developed. With the AVLIS method, only a target isotope is selectively ionized by irradiating a laser to an atomic beam of a metallic element, and then ions of the target isotope are extracted from a current of atomic vapor by applying an electric field to the atomic beam. For example, U.S. Pat. Nos. 4,793,307, 5,202,005, and 5,443,702 disclose methods for separating isotopes, such as mercury Hg, gadolinium Gd, erbium Er, etc. by use of the laser, respectively. Japanese Patent Laid-open Publication No. (H)11-99320 discloses a method which employs a different photoionization pathway of mercury isotope from that of U.S. Pat. No. 4,793,307. In addition, Korean Patent No. 0478533 and PCT WO04/011129 relate to a method for laser isotope separation.

As such, in order to determine whether or not the method for laser isotope separation can be technically realized for a specific element, it is necessary to consider various issues including a selective photoionization pathway, generation of atomic beam, effective collection of photo ions, and the like. Furthermore, it is necessary to have knowledge about atomic parameters such as isotope shift of respective energy states related to the photo-ionization pathway, hyperfine structure, energy, angular momentum, lifetime, etc.

If it is determined that the laser isotope separation can be technically realized for the specific element, economic analysis is performed by comparing a price of a product obtained according to the method for laser isotope separation with that of a product according to other techniques. To this end, it is necessary to consider the number of lasers, output power of laser, line-width of laser, etc, related to the photoionization pathway in combination as well as a physical property of an element determining characteristics of the atomic beam.

One of conventional methods for laser isotope separation of ytterbium is disclosed in Russian Patent RU2119816. This patent relates to a method for isotope separation of ytterbium, and suggests an ytterbium photo-onization pathway of 0 cm⁻¹→17992.007 cm⁻¹→35196.98 cm⁻¹→52353 cm⁻¹. In other words, this patent suggests an ionization process wherein, after exciting a target isotope to 35196.98 cm⁻¹ by use of narrow pulse lasers having wavelengths of 555.65 nm and 581.03 nm, the target isotope is ionized via an autoionization state of 52353 cm⁻¹ by use of a pulsed laser having a wavelength of 582.8 nm. In this regard, influence of a line width and an output density of the laser on isotope selectivity in a three-stage photoionization method using the lasers have been reported via various publications (see G. P. Gupta and B. M. Suri, J. Phys. D, Vol. 35, 1319, 2002, and M. Sankari and M. V. Suryanarayana, J. Phys. B, Vol. 31, 261˜273, 2002). According to this patent, it is necessary to use a laser with a narrow line width of 500 MHz or less in order to enrich 176Yb in a purity of 95% or more, and to maintain intensity of the laser at a predetermined state or less since power broadening guided by the intensity of the laser lowers selectivity during the photoionization. In the method for laser isotope separation, restriction in intensity of the laser leads to reduction in ionization ratio of atom, which is directly connected to a yield, and causes reduction in the yield of a system.

Accordingly, the conventional method for laser isotope separation of ytterbium has several problems in being used for commercial application.

### DISCLOSURE OF INVENTION

### 1. Technical Problem

The present invention has been made to solve the above problems, and it is an object of the present invention to provide a method for laser isotope separation of ytterbium, which can separate a great amount of ytterbium isotope using a commercially available laser to ensure economic efficiency in isotope separation.

### Technical Solution

In accordance with one aspect of the present invention, the above and other objects can be accomplished by the provision of a method for separating a specific isotope of ytterbium from an ytterbium vapor consisting of seven isotopes, ¹⁶⁸Yb, ¹⁷⁰Yb, ¹⁷¹Yb, ¹⁷²Yb, ¹⁷³Yb, ¹⁷⁴Yb, and ¹⁷⁶Yb, comprising the steps of: performing isotope-selective optical pumping through application of a first wavelength photon having a wavelength of 555.65 nm and a second wavelength photon having a wavelength of 1.539 [symbol] to the ytterbium vapor such that an ytterbium atom of a target isotope is changed from a ground state to a metastable state through a first excited state and a second excited state; exciting the ytterbium atom from the metastable state to a third excited state by applying a third wavelength photon to the ytterbium atom in the metastable state, the third wavelength photon having a wavelength selected from 410 nm and 648.9 nm; photoionizing the excited ytterbium atom by applying a fourth wavelength photon having a preset wavelength to the excited ytterbium atom; and collecting photoionized isotope ions of ytterbium.

### Advantageous Effects

The method according to the present invention enables a great amount of ytterbium isotope through a small-sized separation apparatus using a commercially available laser system.

### BRIEF DESCRIPTION OF THE DRAWINGS

The above and other objects, features and other advantages of the present invention will be more clearly understood from the following detailed description taken in conjunction with the accompanying drawings:

FIG. 1 is a schematic diagram illustrating a method for isotope separation of ytterbium;

FIG. 2 is a diagram illustrating a partial energy state of an ytterbium atom;

FIG. 3 is a diagram illustrating isotope shifts and hyperfine structures of an ytterbium energy state related to optical pumping;

FIG. 4 is the optical pumping spectrum of ytterbium isotope calculated in an assumption that optical pumping lasers have an output power of 1 W, and a Gaussian intensity distribution with full width of 10 mm at half maximum;

FIG. 5a is the mass spectrum of a non-selectively photoionized ytterbium atom; and

FIG. 5b is the mass spectrum of a photoionized ytterbium atom when the frequency of the optical pumping laser beam is tuned to the resonance line of ¹⁷⁶Yb.

### BEST MODE FOR CARRYING OUT THE INVENTION

The present invention is a method employing selective photoionization of ytterbium isotopes which enables high efficiency ionization with a high isotope selectivity, followed by isotope separation of ytterbium which extracts selectively photoionized isotope ions of ytterbium to an outside.

In other words, the method according to the present invention is characterized by the selective photoionization of ytterbium isotopes which involves an isotope-selective optical pumping (ISOP) process to optically pump a target isotope into a metastable state, and a resonance photoionization (RPI) process to photoionize an atom of the target isotope from the metastable state to a continuum state or an auto-ionization state through an excited state. The isotope-selective optical pumping can be performed with high efficiency and high selectivity by two continuous wave laser systems which are easily available in the industry, and only the target isotope can remain in the metastable state through such a process. In addition, the resonance photoionization (RPI) process is a process to ionize an atom in the metastable state, and can be performed using a pulsed laser in a visible light range or a pulsed laser in an infrared range.

According to the present invention, since isotope selectivity and ionization of atom are obtained through the ISOP process and the RPI process, respectively, power broadening guided by output of laser does not influence the isotope selectivity. Thus, the present invention enables highly efficient ionization, and is very advantageous in mass production of isotopes of ytterbium.

### MODE FOR THE INVENTION

Preferred embodiments will now be described in detail with reference to the accompanying drawings. It should be noted that the embodiments are provided for the illustrative purpose, and do not limit the scope of the present invention.

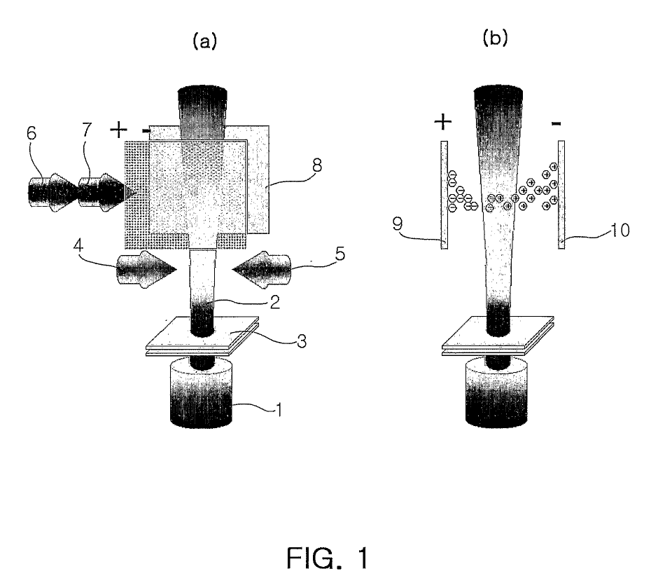

According to the present invention, first, an ytterbium vapor (that is, an ytterbium atomic beam) 2 consisting of seven isotopes, ¹⁶⁸Yb, ¹⁷⁰Yb, ¹⁷¹Yb, ¹⁷²Yb, ¹⁷³Yb, ¹⁷⁴Yb, and ¹⁷⁶Yb, is generated by a heating method using an ytterbium atomic beam generator 1 as shown in FIG. 1. Here, the heating method is not limited to a specific method. For example, the ytterbium atomic beam can be generated by heating ytterbium at 1,000° C. or less. After being generated as above, the ytterbium atomic beam is applied to an atomic beam collimator 3 in order to form an atomic beam having a Doppler line width of 500 MHz or less.

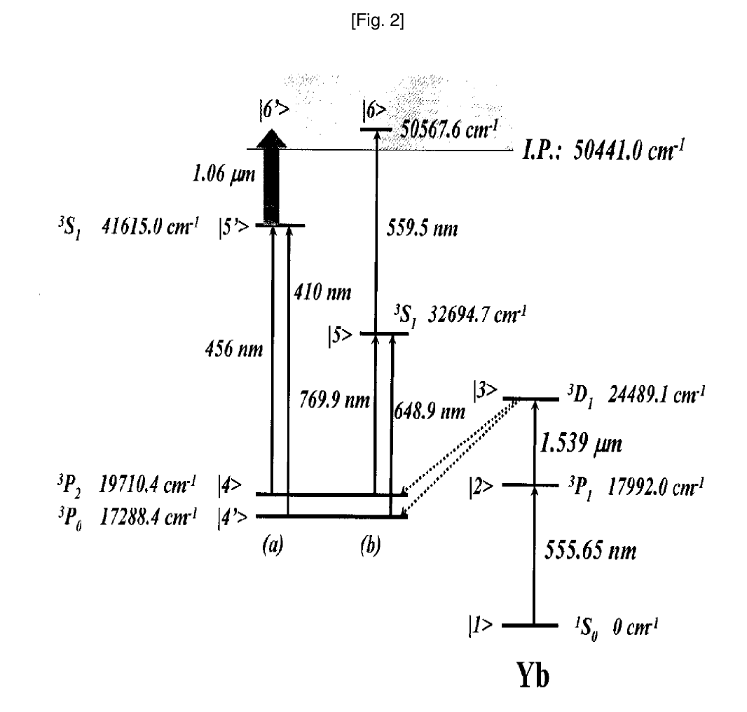

Then, isotope-selective optical pumping is performed by applying a first wavelength photon having a wavelength of 555.65 nm and a second wavelength photon to the ytterbium vapor such that an ytterbium atom of a target isotope is changed from a ground state to a metastable state through a first excited state and a second excited state. At this point, in order to enhance selectivity of the target isotope, it is desirable that both the first wavelength photon and the second wavelength photon be continuous wave lasers. The isotope-selective optical pumping will be described in detail with reference to FIG. 2 hereinafter.

The target isotope among the isotopes of ytterbium in a ground state of |1> is excited to a state of |3> through a state of |2> by virtue of a continuous wave laser having a wavelength of 555.65 mm and a continuous wave laser having a wavelength of 1.539 [symbol] . The target isotope excited to the state of |3> is subjected to a spontaneous decay process to the ground state of |1> again through the excited state of |2>, or optically pumped to a metastable state of |4>. As such, counter-propagation of the continuous wave lasers having the wavelengths of 555.65 nm and 1.539 [symbol] with each other (double-resonance method) enables removal of influence of the Doppler line width of the atomic beam on the selectivity of the isotope during the optical pumping, thereby ensuring a sufficient selectivity of the isotope. Since a lifetime of the |4> state is about several seconds, which is very long, the optically pumped isotope remains in the |4> state for a long period of time. Then, the isotope decayed to the ground state of |1> is excited to the state of |3> by the continuous wave lasers. As such, by repeating the above processes several times, most of the target isotope is optically pumped to the |4> state. At this time, since other isotopes excluding the target isotope are not excited to the |4> state, it is possible to obtain a very high selectivity of the isotope during the optical pumping stage.

An ytterbium atom has a very simple electron energy structure which consists of a ground state (6¹S₀:0 cm⁻¹), two metastable states (6³P₀:17288.4 cm⁻¹, 6³P₂:19710.4 cm⁻¹), and a state (6³P₁:17992.0 cm⁻¹) in an energy state lower than 20000 cm⁻¹. A transition line of 6¹S₀→6³P₁, that is, a transition line starting from the ground state, has a transition wavelength of 555.65 nm, which can be easily obtained by changing a Yb-doped fiber laser in a wavelength range of 1.1 [symbol] commercially available for optical communication to a second harmonic wave. In addition, among transition lines excited from the state of 6³P₁, a transition line of 6³P₁→5³D₁, that is, a transition line excited to 5³D₁, has a wavelength of 1.539 [symbol] which can be obtained by using the commercially available Er-doped fiber laser system.

For the ytterbium atom, since a branching ratio from the state of 5³D₁ to a state of 6³P₀ is 40 times or more than that from the state of 5³D₁ to a state of 6³P₂, a double-resonance transition line by way of 6¹S₀→6³P₁→5³D₁ is very advantageous compared with the optical pumping to the state of 6³P₂. Accordingly, when using the two continuous wave lasers having the wavelengths of 555.65 nm and 1.539 [symbol] as a laser for the optical pumping, it is possible to easily perform the optical pumping of the target isotope in the ground state. In addition, when generating the ytterbium atomic beam at a temperature of 1,000° C. or less, since a population of 6³P_{0,1,2} states is 10⁻⁵ or less, an initial population of 6³P states in this temperature range does not influence the selectivity of the isotope.

Then, the ytterbium atom is excited from the metastable state to a third excited state by applying a third wavelength photon to the ytterbium atom of the metastable state which is obtained by the isotope-selective optical pumping described above. Here, the third wavelength photon is one kind of wavelength photon selected from wavelengths of 410 nm and 648.9 nm.

Then, the excited ytterbium atom is photoionized by applying a fourth wavelength photon having a preset wavelength to the ytterbium atom which is excited to the third excited state. Specifically, when photoionizing the excited ytterbium atom, it is preferable that, if the photon having the wavelength of 410 nm is used as the third wavelength photon, the fourth wavelength photon having a wavelength of 1.06 [symbol] is applied thereto, and if the photon having the wavelength of 648.9 nm is used as the third wavelength photon, the fourth wavelength photon having a wavelength of 559.5 nm is applied thereto.

Here, both the third wavelength photon and the fourth wavelength photon are preferably pulse lasers because the pulsed lasers have a high output power per unit time, and provide a high photoionization ratio.

Excitation to the third excited state and photoionization thereafter will be described in detail with reference to FIG. 2 as follows.

In FIG. 2, the target isotope optically pumped to the state of |4> can be photoionized to a continuum state or an auto-ionization state through an excited state via two pathways. In other words, in the first pathway, the target isotope is excited to a state of |5′> (41615.0 cm⁻¹) as an excited state by applying the third wavelength photon having the wavelength of 410 nm to the target isotope optically pumped to the state of |4>, and is then excited to a state of |6′> as a continuum state by applying the fourth wavelength photon having the wavelength of 1.06 [symbol] to the excited target isotope. The first pathway is advantageous in that it employs the laser having the wavelength of 1.06 [symbol] which is typically used in the art. In addition, in the second pathway, the target isotope is excited to a state of |5> (32694.7 cm⁻¹) as an excited state by applying the third wavelength photon having the wavelength of 648.9 nm to the target isotope optically pumped to the state of |4>, and is then excited to a state of |6> as a continuum state by applying the fourth wavelength photon having the wavelength of 559.5 nm to the excited target isotope.

Then, photoionized isotope ions of ytterbium are collected, so that the target isotope of ytterbium is separated from the ytterbium vapor 2. In FIG. 1, an ytterbium ion collector 8 is used for collecting the photoionized isotope ions of ytterbium. The ytterbium ion collector 8 extracts the photoionized isotope ions of ytterbium by applying an electric field to the photoionized isotope ions of ytterbium.

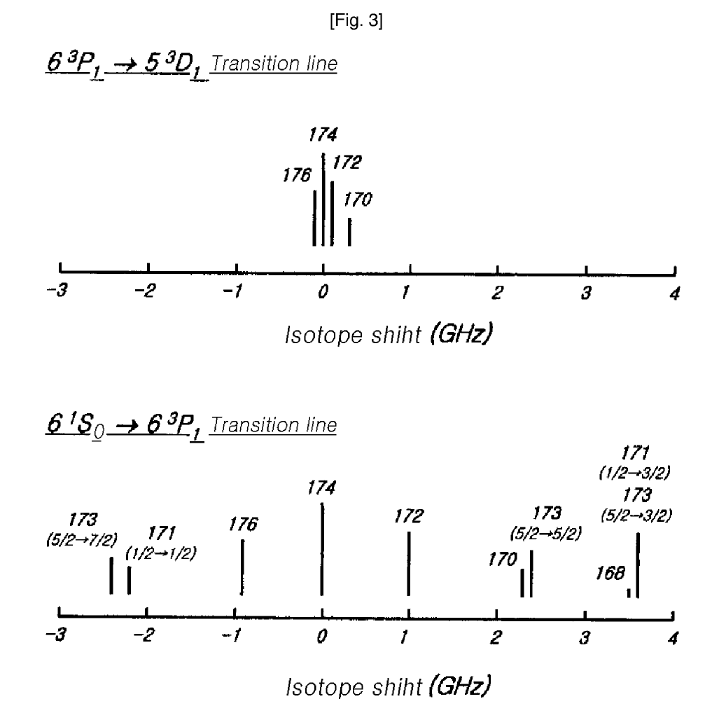

FIG. 3 shows isotope shifts and hyperfine structures of an ytterbium energy state related to an optical pumping transition. As can be appreciated from FIG. 3, an isotope shift in the transition line of 6¹S₀→6³P₁ is about 1 GHz, and an isotope shift in the transition line of 6³P₁→5³D₁ is about 0.15 GHz. Hence, when generating the atomic beam to have a Doppler line width of about 500 MHz or less, and optically pumping the target isotope to a state of 6³P₀ using single-frequency continuous wave lasers having wavelengths of 555.65 nm and 1.539 [symbol] , respectively, it is possible to obtain a very high selectivity of isotope and a high optical pumping efficiency of 90% or more.

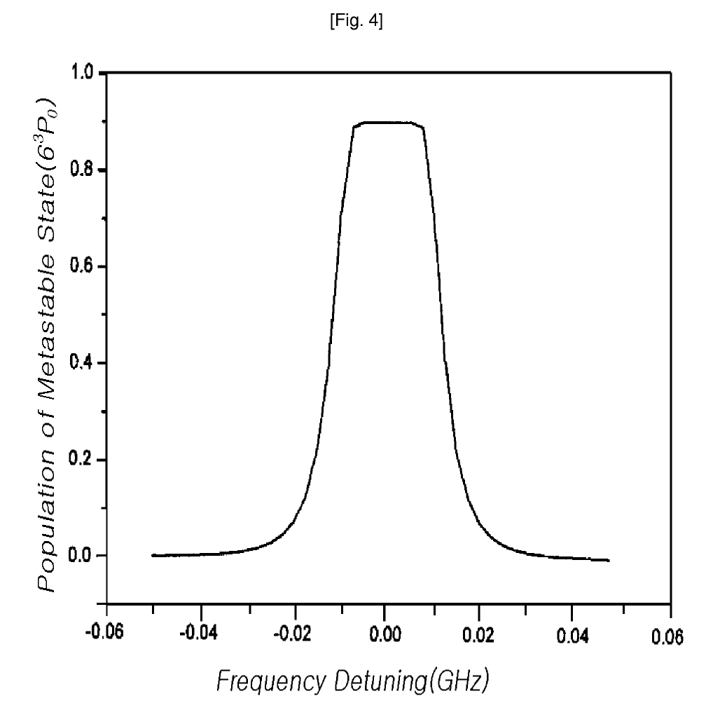

FIG. 4 is the optical pumping spectrum of the transition line of 6¹S₀→6³P₁→5³D₁ as an optical pumping transition line obtained by using two continuous wave lasers which have an output power of 1W and a Gaussian intensity distribution of a full width of 10 mm at half maximum. In FIG. 4, the optical pumping spectrum has a width of about 23 MHz. Thus, considering that the isotope shift of ytterbium is within the range of about 1 GHz, it can be understood that the selectivity of the isotope is very high.

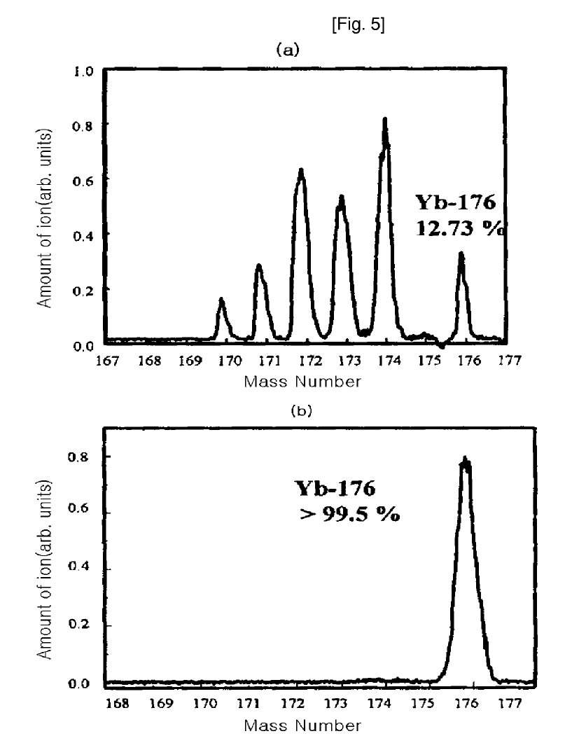

FIG. 5a is the mass spectrum of a non-selectively photo-ionized ytterbium atom, and FIG. 5b is the mass spectrum of a photoionized ytterbium atom measured by using a time-of-flight (TOF) mass spectrometer after photoionizing the isotope of ytterbium according to the present invention. As can be seen from FIGS. 5a and 5b, the method according to the present invention easily enables selective photo-ionization of a specific isotope of ytterbium depending on the wavelengths of the continuous wave lasers which are used as the optical pumping laser. For production of the desired ytterbium isotopes with the capability of 1 [symbol] /year through application of the method of the present invention to separation of ¹⁷⁶Yb, the required laser powers are estimated to be about 500 mW, 4 W, and 400 W for a continuous wave laser, a pulsed visible-light laser for excitation, and a pulsed IR laser for photoionization, respectively. For the pulsed lasers, a repetition rate of about 5 kHz is also required.

It should be understood that the embodiments and the accompanying drawings have been described for illustrative purposes, and the present invention is limited only by the following claims. Further, those skilled in the art will appreciate that various modifications, additions and substitutions are allowed without departing from the scope and spirit of the invention according to the accompanying claims.

1. A method for separating a specific isotope of ytterbium from an ytterbium vapor consisting of seven isotopes, ¹⁶⁸Yb, ¹⁷⁰Yb, ¹⁷¹Yb, ¹⁷²Yb, ¹⁷³Yb, ¹⁷⁴Yb, and ¹⁷⁶Yb, comprising:
performing isotope-selective optical pumping through application of a first wavelength photon having a wavelength of 555.65 nm and a second wavelength photon having a wavelength of 1.539 μm to the ytterbium vapor such that an ytterbium atom of a target isotope is changed from a ground state to a metastable state through a first excited state and a second excited state;
exciting the ytterbium atom from the metastable state to a third excited state by applying a third wavelength photon to the ytterbium atom in the metastable state, the third wavelength photon having a wavelength selected from 410 nm and 648.9 nm;
photoionizing the excited ytterbium atom by applying a fourth wavelength photon having a preset wavelength to the excited ytterbium atom; and
collecting photoionized isotope ions of ytterbium.

2. The method according to claim 1, wherein the first wavelength photon and the second wavelength photon are generated by a continuous wave laser system.

3. The method according to claim 1 or 2, where the isotope-selective optical pumping is performed by allowing the first wavelength photon and the second wavelength photon to optically pump the isotope of ytterbium from the ground state to the metastable state having an energy of 17288.4 cm⁻¹ through the first excited state having an energy of 17992.0 cm⁻¹ and the second excited state having an energy of 24489.1 cm⁻¹ with respect to a zero energy of the ground state.

4. The method according to claim 1, wherein, when the third wavelength photon has the wavelength of 410 nm, the fourth wavelength photon has a wavelength of 1.06 μm.

5. The method according to claim 1, wherein, when the third wavelength photon has the wavelength of 648.9 nm, the fourth wavelength photon has a wavelength of 559.5 nm.

6. The method according to any one of claims 1, 4 and 5, wherein the third wavelength photon and the fourth wavelength photon are generated by a pulse laser system.

7. The method according to claim 1 or 4, wherein excitation from the metastable state to the third excited state by the third wavelength photon is performed by exciting the isotope of ytterbium from the metastable state having an energy of 17288.4 cm⁻¹ to the third excited state having an energy of 41615.0 cm⁻¹ with respect to a zero energy of the ground state.

8. The method according to claim 1 or 5, wherein excitation from the metastable state to the third excited state by the third wavelength photon is performed by exciting the isotope of ytterbium from the metastable state having an energy of 17288.4 cm⁻¹ to the third excited state having an energy of 32694.7 cm⁻¹ with respect to a zero energy of the ground state.

9. The method according to claim 1 or 4, wherein the photoionizing is performed by applying the fourth wavelength photon to the isotope of ytterbium to excite the isotope of ytterbium from the third excited state having an energy of 41615.0 cm⁻¹ to a continuum state in the energy range of 50441.0˜56000 cm⁻¹ with respect to a zero energy of the ground state.

10. The method according to claim 1 or 5, wherein the photoionizing is performed by applying the fourth wavelength photon to the isotope of ytterbium to excite the isotope of ytterbium from the third excited state having an energy of 32694.7 cm⁻¹ to an autoionization state having an energy of 50567.6 cm⁻¹ with respect to a zero energy of the ground state.

11. The method according to claim 1, wherein the collecting photoionized isotope ions of ytterbium is performed by applying an electric field to the ytterbium vapor.
